(19) United States
(12) Patent Application Publication
(10) Pub. No.: US 2017/0083970 A1
(43) Pub. Date: Mar. 23, 2017

(54) DIRECT COMMERCIAL OFFERING AND PUCHASE METHOD FROM SOCIAL NETWORK SITES

(71) Applicant: Flying Saucer Holdings, LLC, Memphis, TX (US)

(72) Inventors: Christopher S. Reckert, Memphis, TN (US); James F. Ruffer, III, Troy, NY (US)

(73) Assignee: Flying Saucer Holdings, LLC

(21) Appl. No.: 15/340,474

(22) Filed: Nov. 1, 2016

Related U.S. Application Data
(63) Continuation of application No. 13/592,130, filed on Aug. 22, 2012, now abandoned.

(51) Int. Cl. G06Q 30/06; H04L 12/58; H04L 29/06; G06Q 30/02

(52) U.S. Cl. CPC G06Q 30/0641; G06Q 30/0277; G06Q 30/0282; H04L 51/32; H04L 63/08; G06Q 50/01

(57) ABSTRACT

A method to permit a visitor to a social network or like website to access commercial information and, ultimately, purchase commercial products from specific vendors without navigating from the social network website itself is provided. Such a method entails the utilization of an overarching navigation protocol through which an advertiser as well as a visitor (user) may access any social network (FACEBOOK, GOGGLE+, FOURSQUARE, TWITTER, PINTEREST, etc.) and provide, as an advertiser, commercial product offerings for review by a user, and, as a user, the capability of reviewing and purchasing such commercial products directly from the social network address. The bridge between the navigation protocol and the target social network, as well as the purchase capability method embedded within the navigation protocol are both encompassed within this invention as well. Furthermore, the utilization of such a purchasing method for any other embedded website is within the scope of the invention, too.

### FIELD OF THE INVENTION

The present invention relates to a method to permit a visitor to a social network or like website to access commercial information and, ultimately, purchase commercial products from specific vendors without navigating from the social network website itself. Such a method entails the utilization of an overarching navigation protocol through which an advertiser as well as a visitor (user) may access any social network (FACEBOOK, GOGGLE+, FOURSQUARE, TWITTER, PINTEREST, etc.) and provide, as an advertiser, commercial product offerings for review by a user, and, as a user, the capability of reviewing and purchasing such commercial products directly from the social network address. The bridge between the navigation protocol and the target social network, as well as the purchase capability method embedded within the navigation protocol are both encompassed within this invention as well. Furthermore, the utilization of such a purchasing method for any other embedded website is within the scope of the invention, too.

### BACKGROUND OF THE PRIOR ART

Social networks, otherwise known as social utilities that track and enable connections between members (including people, businesses, and other entities), have become extremely popular as Internet websites in recent years. In particular, social network websites allow registered members open communication and efficient information sharing capabilities to other registered members, either to all members or to specifically chosen members (such as “friends” or “followers”, as the case may be). Such information sharing includes indicators of members (users) own tastes in various areas, such as music, literature, entertainment, sports, and the like, as well. Additionally, posts of information may include more than opinions, but also links to external websites or other sources on demand, too. Members (again, a/k/a, users) may also search on such sites for specific persons or other entities (such as businesses, organizations, etc.) that may have their own information pages or other type of content. In essence, such social network websites provide users a wealth of information as well as a tool for interacting through an Internet-based platform.

Advertisers have also attempted to leverage this information about website users, targeting their ads to persons and organizations whose interests best align with the subject matter at issue. For example, a social networking website may display banner ads for a concert to members who include an affinity for the performing band in their website profile and live near a concert venue where that band might be performing. Even newer advertising capabilities allow for direct marketing in certain manners by allowing for commercial entities to create their own network pages for users to access and review. However, such prior activities have also proven to be unfortunately limiting in that the user has yet to enjoy sufficient access for commercial entity network sites and pages to actually make direct purchases without actually leaving the social network itself. This drawback has stagnated the commercial possibilities for such social network sites. As a result, although social networks have provided unique and extremely popular outlets for literally hundreds of millions of people, the limitations inherent with such commercial offerings has been an impediment to a one-size-fits-all approach that is sought after for greater efficiencies within the social network realm.

At this point in time, the major sales sites on the Internet are AMAZON.COM and OVERSTOCK.COM, since such companies not only allow for direct access to literally thousands of products through on-site search engines, but also permit purchasing thereon as well (and Amazon includes a well-known “one-click” program to that effect). The lack of social network capability for these sites (at best, users may leave critiques and comments regarding the products available for purchase, but direct sharing beyond such issues is nonexistent) thus renders Amazon and Overstock strictly considered as commercial websites. As well, GOOGLE.COM provides an all-encompassing search engine for myriad Internet sites, but it does not allow for commercial sales directly. Individual websites may be located and accessed through Google, but a user must first leave the starting site in order to do so. Thus, for the time being, at least, Google is a search website, first and foremost (although there is also the capability of instituting individual or group emails, as well; other than such a limited approach, this site, much like YAHOO.COM, as another example, relies on search capability for Internet navigation as its primary basis).

Of significant difference, then, are websites such as FACEBOOK.COM, FOURSQUARE.COM, TWITTER.COM, and PINTEREST.COM (as well as GOOGLE+), to name just a few well-known social network sites. These websites provide, as noted above, an outlet for information sharing of arguably unlimited extent between not only individuals and groups of people (with their own home pages in their respective formats), but also commercial entities through their own company home pages accessible by any registered users. However, these specific commercial pages are severely limited in terms of the information available to users since the commercial sites invariably require a user to navigate off of the network to a separate web address in order to review commercial offerings and/or to make actual purchases of the goods or services made available by such on-line commercial entities. This deficiency has, again, caused a noticeable obstacle to commercial usage of such popular social network sites. If a user accesses such a social network site initially, the necessity to leave, even temporarily, through a link, for instance, could open up an array of potential problems for the user. As it is, the more open sites accessed through such links by a user, the greater the chances for virus attacks, hacking, particularly of credit card or other payment accounts utilized on the commercial entity's own site and/or through the navigation away from an initial site, or other potentially damaging result. Furthermore, as noted above, the availability of a specific commercial entity's own website for such purchases, or the availability of Amazon for such purposes, has proven far easier and less cumbersome to users than accessing such issues through the initial utilization of a social network site. As such, although such social networks have an incredible number of users on a daily basis, the limitations and suspect issues described above, at least, have proven an effective impediment to the commercial sales potential thereof.

Certainly, advertising has been undertaken to a significant level within such social network sites. Without such capability, the intrinsic value of Facebook, etc., would arguably be far less, particularly without a fee structure in place for actual users. The free nature, as it is, enjoyed by such myriad users is not soon to disappear without serious consequence, either. Thus, beyond the utilization of advertising as enticements to users to access certain social network pages or perhaps leave such a network to view individual webpages for commercial entities, the commercial activity available on such social network sites remains minimal, if anything, at best. No improvements to overcome such limitations and commercial obstacles have been effectively implemented let alone proposed in the past. Thus, the capability for users to not only access certain commercial offers from specific vendors through social network sites, but also to purchase directly from such sites (i.e., without any need to leave or link to a site away from the social network itself) would provide a significant development. With such a hoped-for improvement within the social network industry, at the very least, commercial entities could provide similar offerings as Amazon or other sites, such as Overstock, again, as one example, but with the added capability of literally unlimited information sharing between users without any need to leave such a social network site at all. To date, however, such a highly desirable result has not been made available, and certainly not in a reliable manner for vendors and users/purchasers alike.

### ADVANTAGES AND SUMMARY OF THE INVENTION

One distinct advantage of the present invention, then, is the capability of providing direct access to commercial product offerings through a social network page without any need for navigating to a different web address. Another advantage is the added potential to utilize a direct purchasing platform integrated within the social network commercial product offering protocol. Yet another advantage of the inventive system and method is the facilitation of vendor listings through relatively straightforward and single information input and entry regarding commercial product and service offerings that becomes present on all selected social network sites. Still another advantage is the added possibility of including a payment button (program) simultaneously with such commercial product and service offerings to permit a complete vendor/customer transaction from all selected social network sites. Still another advantage of this overall invention is the potential for users that undertake such purchasers to indicate to other social network users their actual purchases/actions and to suggest/comment thereon for external marketing purposes. Yet another advantage of such an inventive system is the capability of the social network at issue to capture the actions of purchasers through such a commercial offering/purchasing protocol and allow advertisers to direct market similar products and/or services to such individuals in the future.

Accordingly, this invention encompasses a method of providing at least one commercial offering on at least one social network website, wherein said method comprises the steps of providing a base website separate and distinct from said at least one social network website; providing a bridge protocol program to permit placement of authenticated data input from said base website onto said at least one social network website; accepting commercial information from at least one vendor in the form of authenticated data onto said base website, wherein said authenticated data pertains to at least one commercial product or service offering from said vendor; transfer of said authenticated data from said base website to said social network website through the utilization of said bridge protocol program; and placing said authenticated data on said social network website as a commercial offering from said at least one vendor such that said offering is reviewable by at least one purchasing user on said at least one social network website without any need to leave or link to any other website.

Additionally, the overall method or system may include a purchasing program introduced within said base website that allows said at least vendor user the capability of having said at least one purchasing user purchase the commercial product or service without leaving said at least one social network website. The bridge protocol established herein allows for the base website to collect authentic data inputted from the vendor user and place it on the targeted social network website, such as described below (as one potentially preferred embodiment) via the vendor's own page, account, etc., on the targeted social network website.

Alternatively, the inventive system or method may be considered to encompass the broad method of directly purchasing a good or service while registered to a social network website and without leaving or linking to a different website. Thus, the invention encompasses a method of permitting a social network member to directly purchase a good or service while accessing a social network website, wherein said method comprises the placement of a commercial offering for a good or service on said social network website; the review of said commercial offering for a good or service by said social network member; and the subsequent purchase of said commercial offering for a good or service on said social network website by said social network member; wherein said review and said purchase are all performed by said social network member while remaining on said social network website. In this manner, the term “without leaving or linking to a different website” is intended to mean that the purchasing user will not be moved to a different URL address during review and purchase on the target social network website. Such a meaning is also ascribed to the description as “remaining on” such a social network website. Furthermore, such an invention may permit a purchasing user the capability of providing comments, ratings, and/or suggestions regarding said commercial offering for review by other members of the same social network website.

As noted above, the potential for utilization of social network websites for all-in-one platforms for information sharing and direct communication between registered user as well as for commercial offerings has never come to fruition. Without question, the basic capacity has been well utilized for information and communication systems, and, again, without question, the revenue generation importance of advertising on such websites has become well-established, as well. The next step in allowing for full commercial catalogs or other product/service offerings without navigating from the social network website at issue has now been accomplished. This leads not only into uncharted territory but unlimited potential for such social network sites to become one-stop locations, thus further allowing vendor users (i.e., those users that are placing commercial offerings on the websites) greater control and capability of reaching potential purchasers with reliability and security in terms of not only on-line product/service offers, but, with the correct systems in place, reliability and security for actual purchases to be made through the same protocols. Such a paradigm breaker is thus highly surprising in its effectiveness as well as its overall viability. The potential to allow myriad vendor users such capabilities is not an easy hurdle to overcome, particularly as it pertains to the completeness of such commercial offerings (for instance, the breadth of product displays and descriptions without the need to link to such a commercial entity's own website). Including the possibility of a suitable purchasing/payment program that, again, does not require the purchasing user (i.e., the user that reviews a vendor user's offering and buys such a product or service through the social network website) to access any other website for authentication/security, etc., details, and the overall inventive system and method is a far cry from the standards in place from today, as well.

To that end, then, the inventive system utilizes an initial base website that serves as the platform for all necessary pathways to follow. Such a base website is provided on a web server (such as Explorer or Chrome, as examples), just as any other website, including those herein defined as social network websites. This base provides all the necessary programs to connect with targeted social networks and, as a result, act as a platform for access to such sites. In this manner, a vendor user may employ the base website to provide information to be posted on any connected social network; as well, a purchaser user may locate such information (such as product offerings, deals, etc.) posted by a vendor user on the social network website for review. The base website also allows, as noted previously, the added introduction of a payment feature that is keyed into the overall base website structure and thus may be implemented in relation to the product/service offerings posted via the base website to the social network website(s). In this manner, any vendor user may simply log onto the base website and upload any commercial offering information (with a payment program pulled in if desired) in order for such information, etc., to then transfer to each connected social network website(s). Any purchasing user accessing such a connected social network website may then also have access to such commercial information for full review thereof while remaining within the confines of the social network site, with the added potential to purchase such a commercial offering without having to leave such a site, either.

This platform thus accomplishes a result that has heretofore been unavailable through standard social network protocols. Through the connection with a base website, a vendor, of any type, size, etc., may introduce and post as much commercial information as desired directly to a social website in order for a potential purchaser to locate and review all such commercial information without the need to access any other external website (such as a specific vendor's own website). Each product offering may be posted separately by a vendor, or, if desired, a catalog of information (including prices, alternative makes and models, etc.) may be uploaded in like fashion for potential purchasing user review. In any event, the base website connection to the social network addresses provides the unexpectedly effective results for broader reach to the purchasing public. Furthermore, with the coupling of commercial information to purchasing users' self-proclaimed tastes, as well as the potential to further investigate and understand such purchasing users' own historical posts for commercial potential, the base website further provides a platform from which advertisers/vendors may target specific purchasing users for centered attention. Likewise, purchasing users may provide their own supportive comments and suggestions to other users on such social network websites, thus potentially acting as proper commercial drivers all by themselves.

Additionally, the base website may also act as a launching pad of sorts for the payment program beyond its implementation within connected social network commercial offerings. Such a program may also be related with other gateway programs and/or APIs for pull-through implementation on demand with other commercial websites. The versatility of the overall base website platform, coupled with the payment program, then opens up vast opportunities within the commercial Internet industry, all from a single site without any need to navigate from such a secure and reliable starting point. The avoidance of potential hacking, virus attack, and other deleterious result from moving and/or migrating from website to website, thus provides yet another significant improvement over the current state of the art.

Thus, through a properly integrated computer, smart phone, or other Internet-connected device, the present invention allows for any type of user, vendor or purchaser, the ability to truly reach out to any other user on a social network and reliably and securely open up lines of commerce that have heretofore been effectively impeded.

### BRIEF DESCRIPTION OF THE DRAWINGS

FIG. 1 is a high-level block diagram illustrating one potentially preferred embodiment of the inventive system and method utilizing a base website for connection to social network websites for commercial product/service offerings and potential purchases while logged onto a social network.

FIG. 2 is a network diagram of a potentially preferred embodiment of the inventive system for a vendor user to implement a commercial offering onto a social network.

FIG. 3 is a network diagram of a potentially preferred embodiment of the inventive system for a vendor user to implement a payment program in conjunction with the commercial offering in FIG. 2.

FIG. 4 is a network diagram potentially preferred embodiment of the inventive system for a purchasing user to access a commercial offering and utilize a payment program in conjunction with the commercial offering in FIG. 3.

The figures depict various embodiments of the present invention for purposes of illustration only. One skilled in the art will readily recognize from the following discussion that alternative embodiments of the structures and methods illustrated herein may be employed without departing from the principles of the invention described herein.

### DETAILED DESCRIPTION OF THE DRAWINGS AND PREFERRED EMBODIMENTS

References herein to computers, computer systems, or servers refer to computer processing units, such as computer servers, personal computers or workstations. Although not depicted in the figures, the one or more computers referenced herein generally include such art recognized components as are ordinarily found in such computer systems, including but not limited to processors, RAM, ROM, hard disks or other computer readable mediums, clocks, hardware drivers, associated storage, and the like. References herein to the term “database,” “database system,” or “database server” generally refer to one or more storage devices or computers with storage media storing a collection of records or data, as well as software for managing such records or data (commonly known as a database management system (or DBMS)). The database may take the form of a relational, hierarchical, network, or other known structure as may be deemed to be most efficient.

Furthermore, each of the computer systems described herein (the base website and the social network websites) preferably includes a network connection. The network connection may be a gateway interface to the Internet or any other communications network through which the systems can communicate with other systems and user devices. The network connection may connect to the communications network through use of a conventional modem (at any known or later developed baud rate), an open line connection (e.g., digital subscriber lines or cable connections), satellite receivers/transmitters, wireless communication receivers/transmitters, or any other network connection device as known in the art now or in the future. As such, such social network access may be accomplished through standard computers, smart televisions, gaming consoles (MICROSOFT WII, SONY PLAYSTATION, and the like, for instance), and any other like device with similar capacity.

To that end, then, additionally, the overall concept also includes connections made in the same manner with mobile devices, such as, for instance, smart phones, tablets, iPods, iPads, and other like items (including the utilization of an App for such a purpose). As such, the communication and connection systems noted above also apply for these devices. Full accessibility through such mobile platforms is thus contemplated for the inventive method and system in the same manner as is and will be described herein as it applies to any other Internet-based protocol.

### Overview of System and System Architecture

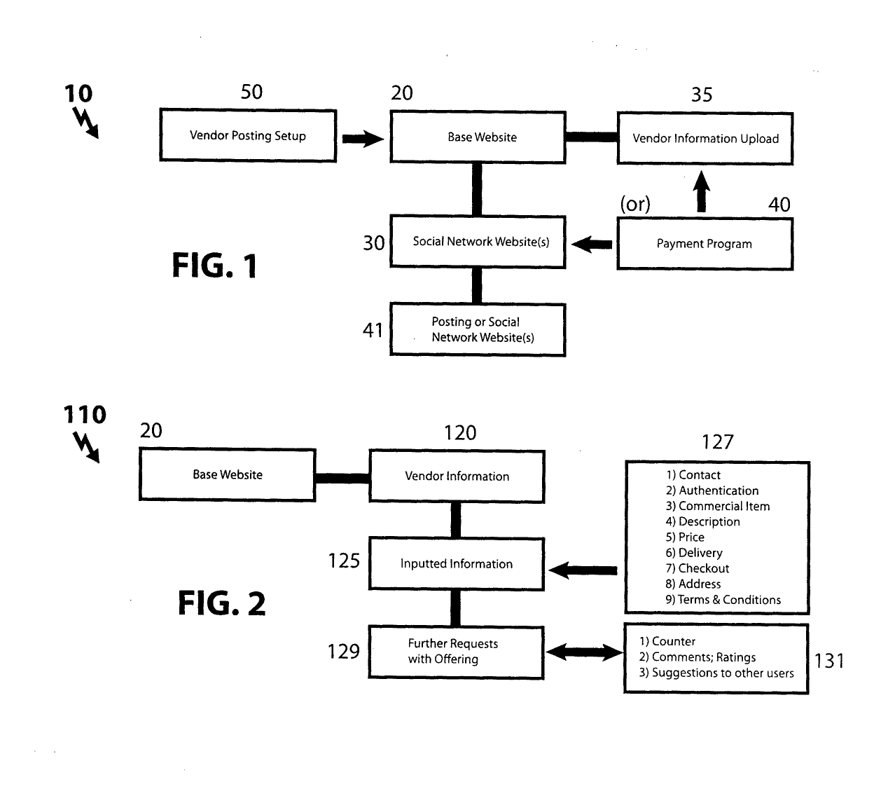

FIG. 1 thus provides an overview of one potentially preferred embodiment of the inventive system 10 from initial set-up to actual utilization for commercial purchases through a social network setting. The base website 20 is first created out of a LAMP stack, allowing for access from a typical web server. A suitable Application Program Interface is instituted for proper communication between different websites, utilizing any standard language, such as HTML, PHP, or Java, as non-limiting examples. The base website 20 is programmed with a suitable framework to connect with any selected external website through its API (referred to herein as a “bridge protocol”). In this situation, then, the base website 20 is configured as a social media engine utilizing PHP with a Cake framework with MySQL database for this purpose. This engine capability thus permits the straight connection between the base website 20 and the social network 30 such that uploaded commercial information 35 from a vendor user (such as in FIG. 2, below) onto the base website 20 is automatically made accessible on such a social network 30. This may be accomplished, and as one potentially preferred embodiment, through the utilization of an iframe platform that places all such uploaded vendor information, at least, within the confines of the vendor's own social network page (i.e., a posting that is a “window within a window” as it were, again, as one non-limiting example). In such a manner, the vendor set-up basically includes a request from the base website to access the vendor user's social network website page (or like screen unique to such a vendor) for placement of such an iframe platform. From that point, any user accessing such a social network 30 will also have access to the commercial information 35 for full review and consideration thereof The user, which may be a vendor or a purchaser (i.e., a typical person or other entity accessing a social network for social purposes, including potentially buying commercial goods/services offered therein), thus has the full range of activities for social network navigation as would a user that is logged-in through the social network directly.

The system may also include, as noted above, a payment program 40 that allows for direct input of purchasing information (such as credit card, gift card, loyalty points or credits, debit card, etc., data, basically any type of electronic payment) from a user through a secure system (denoted typically by a secure hypertext transfer protocol). Such a program is configured through such a standard protocol and is compatible with the base website architecture for implementation therewith. Such a program includes a straightforward payment “button” that may be clicked to indicate payment is to be transferred from an inputted source to a commercial entity (vendor) in relation to a selected and purchased good or service. To allow for utilization by both a vendor and a purchaser, such a program will thus include a vendor set-up and validation component to accomplish the proper transfer of funds upon activation by a purchaser. Likewise, in order to guarantee that proper debit from a purchaser's account is made for such a purpose, the program will include a suitable validation component and set-up for each specific purchaser subsequent to “button” activation, with the added potential for such a system to store specific purchaser information for future purchases without the need for further information input, but with a validation authentication (such as a two-factor, password, or other like device), if so desired. In any event, through the utilization of the base website 20, the integrated payment program 40 provides the capacity for a purchaser direct payment options for a selected commercial good or service made available through the social media engine provided therein.

Avoidance of external navigation (again, denoted as not moving from the social network URL address, or, alternatively, as remaining on the social network website as denoted by the same URL address) from a selected social network website 30 for commercial offering reviews and purchases is thus possible through this overall system structure. The API of the payment program 40 is effectively “called” by the base website 20 when activated by a purchaser, thus keeping the purchaser within the confines of the specific social network website address to accomplish such an end result. Proper price calculations, shipping and handling additions, and any other costs (taxes, if implemented, for instance), are made and included within the final purchase price for which payment is then made, as well. From there, delivery information is captured and conveyed to the vendor through the overall secure protocol, allowing for direct sales between a vendor and purchaser without actually leaving a social network address.

Such a platform thus merely requires vendor user input onto/into the base website 20 of commercial offering information (vendor information, commercial good(s)/service(s) information, prices, availability, shipping/handling costs, checkout options, etc.) in order to effectuate the desired placement of such information on connected social network website(s) 30.

Initial Set-Up with Vendor on Base Website for Posting on Social Network

FIG. 2 shows the vendor user set-up process 110 within the base website 20. As noted above, such a vendor user may access the website 20 through a typical web server (for instance, a web address for one potentially preferred base site 20 would be www.yapyzal.com). A vendor user may then request a posting to any connected social network (such as Facebook, Foursquare, Twitter, and the like), and then provide the necessary information on a single or multiple screens 125 for proper uploading 120 of the desired information to be posted (preferably, again, a commercial offering or offerings). Thus, a vendor would include the following information 127 to validate such a request: 1) Vendor contact information; 2) authentication of identification for uploading to other platforms (i.e., proper password or other like device); 3) Commercial item title; 4) Commercial item description; 5) Commercial item price; 6) Delivery options and prices; 7) Checkout options (payment alternatives); 8) Delivery address(es) (including email information for further communications with the purchasing user); and 9) purchasing agreement Terms and Conditions. Such a posting thus may be of a single item or multiple items (goods or services), and may also be indicated as a coupon or other type of offer at a lower price than commonly requested.

The vendor user thus must first validate that such an offering is authentic, both in terms of the goods/services at issue, as well as it pertains to the identity 127-1 and existence of the specific vendor user itself 127-2.

A proper listing 127-3 (whether in a single offering or in a catalog-like presentation) may be implemented with proper explanation/descriptions thereof, including, as needed and as desired, any photographs, graphics, audio files, video presentations, and any other depiction of the commercial offering itself 127-4. The base website 20 will include proper language and programs (Java, etc.) to permit transfer of such depictions as requested as well (with, of course, certain limitations as to content and necessary memory for actual implementation on the target social network site). The overall description would then include requested price(s) 127-5 for consideration by a purchasing user, as well as, as alluded to above, any possible reductions allowed (such as, for instance, within a certain time frame, or, alternatively, again, as merely one example, a price break if the purchaser is a member of a certain group or organization, or even a general price concession as a promotional program).

Upon selection by a purchasing user, then, the overall commercial offering will include options for proper delivery 127-6 to such a user. Thus, time-based delivery issues may be accommodated (overnight, 2-day, etc., delivery), or standard first-class to as low as fourth-class post may be available on demand (with certain prices for each indicated, as well). Additionally, any issues with extraterritorial shipping may be indicated with alternative choices provided as well.

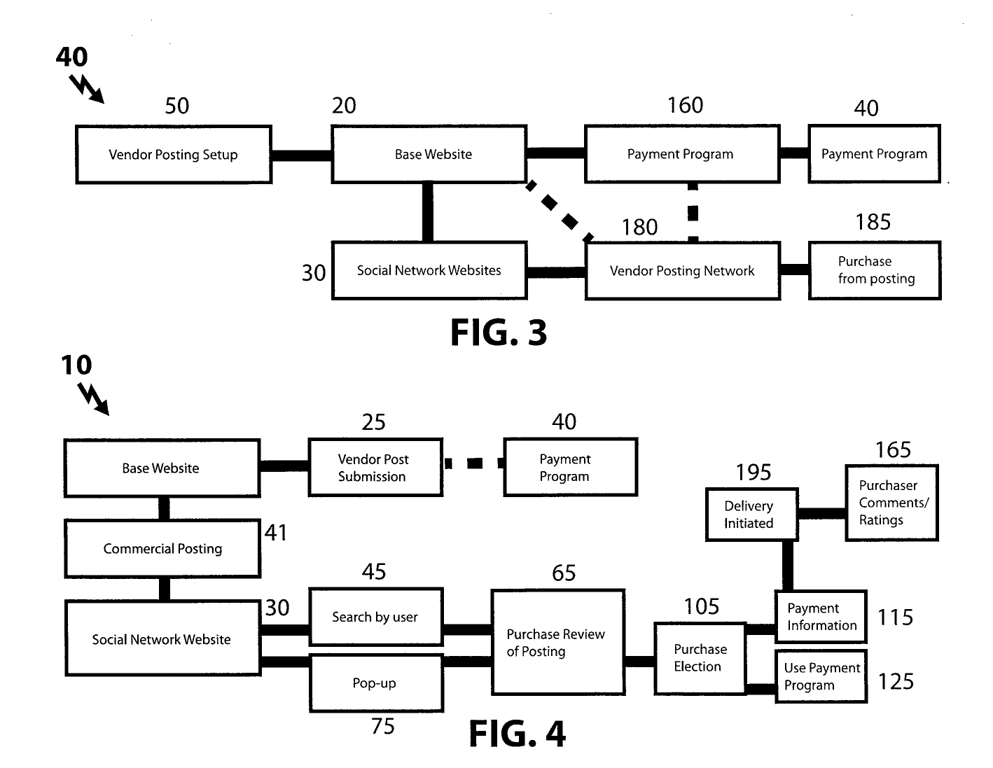

Payment alternatives 127-7 would also be provided by the vendor user in order to ensure receipt of tender prior to shipping or other performance under the commercial agreement created thereby. Thus, direct communication (email, telephone) with purchaser information (credit or debit card, for instance, or gift card, as another) may be indicated. As well, any other manner of acceptable payment may be permitted, with external payment programs, on-line loyalty points (by, for instance, having social network members accumulate points or credits that may be utilized as on-line currency that permits vendor recoupment directly or indirectly from the network if and when exercised), or even C.O.D., if desired, noted. Additionally, however, and as one potentially preferred embodiment of this inventive method and system, would be the inclusion of an integrated payment program (as in FIG. 3, below). The delivery address 127-8 would then be included as well. Such a delivery issue may also allow for the purchasing user to “reserve” the item to be purchased such that the purchasing user may elect to pick up such an item himself or herself directly from the vendor (for example, if the vendor is local or at least within a certain distance from the purchaser at the time).

Additionally, then, the vendor would include a presentation of the Terms and Conditions 127-9 that govern the commercial purchase for the purchasing user to review and indicate acceptance thereof prior to completion of the transaction. A box or button may be provided on the screen for such an indication to be made by the purchaser.

Such a vendor user request may also include a number of other components 129. For instance, and without limitation, vendors may also request a counter for numbers of times the specific posting was accessed on a social network website 131-1. Additionally, again, without limitation, the vendor may request inclusion of a “like” indicator (or similar type device), as well as a possible grading system for purchasing users to indicate their approval subjectively or objectively of a commercial offering (subsequent to purchase) 131-2. Additionally, the vendor user may further, without limitation, request the capability of a purchasing user to suggest or forward such a commercial offering to any number of other users, either individually, or, perhaps, to the entire group of “friends,” “followers,” or other like users on the target social network website 131-3. To a further degree, a purchasing user may be permitted the capability to comment in writing, through audio, or even via video regarding such a purchase, as well.

In this manner, then, if desired, the vendor user may compile all such purchasing user comments, ratings, etc., and include them within future commercial offerings by updating or having automatic updates provided by the base website 20.

Furthermore, such a vendor request 129 may also include an inventory monitor to alert potential purchasers of specific amounts of goods within the commercial offering that remain for purchase (with updates as such goods are actually purchased).

Such commercial offerings may also be utilized for other pursuits, including, without limitation, charitable or other donation-based causes (religious institutions, public broadcasting events, non-profit organizations, political contributions, etc.). In this manner, a vendor user would provide an offering as a request for donations, services, and the like, and post such a request on a social network. The overall system and method would be employed in the same manner as for commercial activities, and payments would be made in a like manner as well. There may be exchanged goods, as well, that may be delivered in return for certain donations that would allow for delivery options and prices to be included within the information inputted for such a purpose by the vendor user. Additionally, vendors may also seek barter systems through such a system and method on occasion. The information, etc., inputted by the vendor user may be modified to such an extent, if desired.

The utilization of ratings, comments, etc., in relation to such alternative vendor user services could also be implemented as needed and/or as desired, as well.

As a result, the term “commercial offerings” as it applies to the invention described herein is intended to encompass not only strict sales/purchases of goods or services, but also the potential for such charitable/donation-based possibilities and bartering arrangements as noted above, as well.

Payment Program Introduction and Implementation with Commercial Offerings

FIG. 3 provides an outline of the inclusion of a direct payment program within the overall inventive system and method. As noted previously, although the utilization of a base website 20 permits direct posting of commercial (and potentially other) offerings onto connected social network websites 30, and thus the capability of a purchasing user (i.e., social network member) to remain at the specific social network address while reviewing and deciding on purchasing or otherwise utilizing such commercial offerings, the overall purchasing experience would reach its apex if actual payment processing were permitted for such a purchasing user without the need to leave such a social network site 30, either. The inventive system and method thus compensates for such a situation through the availability of a suitably configured payment program 160 that is accessible by a vendor user through proper selection and inputting of information 170, as well as indication that such a program 160 should be pulled into the actual posting 180 upon proper request during commercial offering set-up 50 or after such has occurred. Such a program 160 allows for communication with the base website 20 upon activation by a purchasing user 190 during a purchasing event 185 from a commercial offering 180 posted to a social network website 30. The vendor user would first request such an add-on to his or her commercial offering post (again, either during or after posting set-up) with proper authentication as to vendor identity, financial institution depository identity and proper account number, and other such information. The capability of such a payment program 60 to simply communicate directly with the base website 20 upon purchasing user activation thus allows such a user to, again, remain on the social network website 20 without any need to leave or entrust his or her financial or other information to another outside source. Upon proper inputting of necessary information upon request by the payment program 60 (such as, purchasing user identity, financial resource account information, whether by credit/debit/coupon/other source), upon activation of the supplied “button” by the purchasing user, then payment may be properly made and the transaction sought may be completed.

### Full Utilization of Commercial Purchase Platform on Social Networks

Thus, as one potentially preferred embodiment, FIG. 4 shows the overall commercial activity system and method 10 of this invention. A vendor user accesses the base website 20, posts a commercial offering 25, alternatively includes addition of a payment program 35 subsequent to authentication proceedings with the posting 40. Such a posting 40 then is automatically placed onto a selected social network website(s) 30, with or without the payment program addition 35. A social network member (a/k/a, purchasing user) may then access a social network website 30 and review 65 the posting 40 supplied by the vendor user through the connection of the base website 20 with the social network website 30. Such a posting 40 may be supplied through direct searching by a purchasing user 45, or through a pop-up advertisement supplied 75 through the activation by the base website 20. As noted above, such pop-up advertisements 75 may be accomplished through the compilation of information pertaining to specific purchasing users, either gained through information supplied by the social network site 30 or through historical data (i.e., comments, prior purchases) and/or suggestions provided from other purchasing users to specific other users 85. In any event, upon review 65 of such a posting 40, a purchasing user may then elect to purchase (or donate or barter, as the case may be, as discussed above) the offered goods and/or services for a certain price 105. At that point, the purchasing user may then provide payment information 115 to the base website 20 through the posting particulars, as discussed previously, or, alternatively, if the vendor user has included the payment program 60 as a means for such a payment process, the purchasing user may utilize such a program 125, without the need to contact the vendor or otherwise leave the social network website 30 at all. At that point, the transaction is complete, a receipt is provided to the purchasing user on-screen and/or through email, and an order is sent to the vendor to effectuate delivery of the purchased goods/provides the services 195. Subsequent to such a purchase, then, the purchasing user may then utilize an alternative comment or rating device to provide insight to other users into his or her purchasing experience, as well as the quality of the purchased good or service 165.

In this manner, then, an entire advertisement/product offering/purchase system 10 is permitted with great reliability and security to both vendors and purchasers all within the confines of a single social network website. Individual deals or entire catalogues of goods/services may be offered in this way, thus allowing any vendor the chance to connect with myriad potential purchasers through a social network experience without any need for external navigation away from such a website.

The foregoing description of the embodiments of the invention has been presented for the purpose of illustration; it is not intended to be exhaustive or to limit the invention to the precise forms disclosed. Persons skilled in the relevant art can appreciate that many modifications and variations are possible in light of the above disclosure. For example, although the foregoing embodiments have been described in the context of a social network website, it will apparent to one of ordinary skill in the art that the invention may be used with any electronic social network service and, even if it is not provided through a website. Any computer-based system that provides social networking functionality can be used in accordance with the present invention even if it relies, for example, on e-mail, instant messaging or other form of peer-to-peer communications, and any other technique for communicating between users. The invention is thus not limited to any particular type of communication system, network, protocol, format or application.

Some portions of this description describe the embodiments of the invention in terms of algorithms and symbolic representations of operations on information. These algorithmic descriptions and representations are commonly used by those skilled in the data processing arts to convey the substance of their work effectively to others skilled in the art. These operations, while described functionally, computationally, or logically, are understood to be implemented by computer programs or equivalent electrical circuits, microcode, or the like. Furthermore, it has also proven convenient at times, to refer to these arrangements of operations as modules, without loss of generality. The described operations and their associated modules may be embodied in software, firmware, hardware, or any combinations thereof

Any of the steps, operations, or processes described herein may be performed or implemented with one or more hardware or software modules, alone or in combination with other devices. In one embodiment, a software module is implemented with a computer program product comprising a computer-readable medium containing computer program code, which can be executed by a computer processor for performing any or all of the steps, operations, or processes described.

Embodiments of the invention may also relate to an apparatus for performing the operations herein. This apparatus may be specially constructed for the required purposes, and/or it may comprise a general-purpose computing device selectively activated or reconfigured by a computer program stored in the computer. Such a computer program may be stored in a tangible computer readable storage medium or any type of media suitable for storing electronic instructions, and coupled to a computer system bus. Furthermore, any computing systems referred to in the specification may include a single processor or may be architectures employing multiple processor designs for increased computing capability.

Embodiments of the invention may also relate to a computer data signal embodied in a carrier wave, where the computer data signal includes any embodiment of a computer program product or other data combination described herein. The computer data signal is a product that is presented in a tangible medium or carrier wave and modulated or otherwise encoded in the carrier wave, which is tangible, and transmitted according to any suitable transmission method.

Finally, the language used in the specification has been principally selected for readability and instructional purposes, and it may not have been selected to delineate or circumscribe the inventive subject matter. It is therefore intended that the scope of the invention be limited not by this detailed description, but rather by any claims that issue on an application based hereon. Accordingly, the disclosure of the embodiments of the invention is intended to be illustrative, but not limiting, of the scope of the invention, which is set forth in the following claims.

What is claimed is:

1. A method of providing at least one commercial offering on at least one social network website, wherein said method comprises the steps of:
a) providing a base website separate and distinct from said at least one social network website;
b) providing a bridge protocol program to permit placement of authenticated data input from said base website onto said at least one social network website;
c) accepting commercial information from at least one vendor in the form of authenticated data onto said base website, wherein said authenticated data pertains to at least one commercial product or service offering from said vendor;
d) transferring said authenticated data from said base website to said social network website through the utilization of said bridge protocol program; and
e) placing said authenticated data on said social network website as a commercial offering from said at least one vendor such that said offering is reviewable by at least one purchasing user on said at least one social network website without any need to leave or link to any other website.

2. The method of claim 1 wherein said method further includes a purchasing program introduced within said base website that allows said at least vendor user the capability of having said at least one purchasing user purchase the commercial product or service without leaving said at least one social network website.

3. A method of permitting a social network member to directly purchase a good or service while accessing a social network website, wherein said method comprises:
a) the placement of a commercial offering for a good or service on said social network website;
b) the review of said commercial offering for a good or service by said social network member; and
c) the subsequent purchase of said commercial offering for a good or service on said social network website by said social network member;
wherein said review and said purchase are all performed by said social network member while remaining on said social network website.

4. The method of claim 4 wherein said method further includes the capability of said social network member to provide comments, ratings, and/or suggestions regarding said commercial offering for review by other members of the same social network website.
